(19) United States
(12) Patent Application Publication
(10) Pub. No.: US 2026/0230301 A1
(43) Pub. Date: Aug. 6, 2026

(54) SERVER APPARATUS, ELECTRONIC APPARATUS, METHOD OF OPERATING THE SAME, AND STORAGE MEDIUM FOR PROCESSING HOMOMORPHIC CIPHERTEXT

(71) Applicant: CRYPTO LAB INC., Seoul (KR)

(72) Inventors: Junbum Shin, Suwon-si (KR); Soo-Heang Eo, Seoul (KR)

(21) Appl. No.: 19/530,264

(22) Filed: Feb. 4, 2026

(30) Foreign Application Priority Data
Feb. 5, 2025 (KR) 10-2025-0014699
Jan. 16, 2026 (KR) 10-2026-0009235

(51) Int. Cl. H04L 9/00; G06F 16/334

(52) U.S. Cl. CPC H04L 9/008; G06F 16/3347

(57) ABSTRACT

A server apparatus includes a communication circuit configured to communicate with at least one electronic apparatus, at least one processor including a processing circuitry, and a memory configured to store an encrypted retrieval-augmented generation (RAG) database including instructions, one or more storage media, and at least one homomorphically encrypted information, in which the instructions, when individually or collectively executed by the at least one processor, cause the server apparatus to search the encrypted RAG database based on a query obtained from a first electronic apparatus among the at least one electronic apparatus via the communication circuit; obtain response ciphertext based on the homomorphically encrypted information identified through the search; and transmit the response ciphertext to the first electronic apparatus via the communication circuit.

### CROSS-REFERENCE TO RELATED APPLICATION(S)

This application claims benefit of priority to Korean Patent Application No. 10-2025-0014699 filed on Feb. 5, 2025, in the Korean Intellectual Property Office, and Korean Patent Application No. 10-2026-0009235 filed on Jan. 16, 2026, in the Korean Intellectual Property Office, the disclosure of which is incorporated herein by reference in its entirety.

### BACKGROUND

### Field

Apparatuses and methods consistent with the disclosure relate to a server apparatus, an electronic apparatus, a method of operating the same, and storage media that provide an artificial intelligence service based on retrieval augmentation generation while preserving privacy using homomorphic encryption technology.

### Description of the Related Art

As communication technology develops and electronic apparatuses spread, efforts are continuously made to maintain communication security between the electronic apparatuses. Accordingly, encryption and decryption technology is used in most communication environments.

As one of the encryption technologies, in recent years, a homomorphic encryption method has been actively researched. According to the homomorphic encryption, decrypting the results of operation on ciphertext may obtain values that match the corresponding results of operation on plaintext. Accordingly, various operations may be performed without decrypting the ciphertext.

Based on these characteristics, a system has been proposed in which data is homomorphically encrypted and stored, and searches are performed in a ciphertext state.

### SUMMARY

Embodiments of the present disclosure may address at least one of the aforementioned problems and/or disadvantages and provide the advantages described below. Accordingly, the embodiments of the present disclosure provide a server apparatus, an electronic apparatus, a method of operating the same, and storage media that provides an artificial intelligence service based on retrieval augmentation generation.

Additional embodiments will be presented in the detailed description to be described below, some of which will be apparent from the detailed description, and other embodiments may also be presented through learning from the presented embodiments.

According to an embodiment of the disclosure, a server apparatus includes: a communication circuit configured to communicate with at least one electronic apparatus; at least one processor including a processing circuitry; and a memory configured to store an encrypted retrieval-augmented generation (RAG) database including instructions, one or more storage media, and at least one homomorphically encrypted information, in which the instructions, when individually or collectively executed by the at least one processor, cause the server apparatus to search the encrypted RAG database based on a query obtained from a first electronic apparatus among the at least one electronic apparatus via the communication circuit, obtain response ciphertext based on the homomorphically encrypted information identified through the search, and transmit the response ciphertext to the first electronic apparatus via the communication circuit.

The query may be a homomorphically encrypted query, and the instructions, when individually or collectively executed by the at least one processor, may cause the server apparatus to perform a homomorphic operation between the homomorphically encrypted query and the at least one homomorphically encrypted information to perform the search.

The instructions, when individually or collectively executed by the at least one processor, may cause the server apparatus to store homomorphically encrypted information obtained from a second electronic apparatus among the at least one electronic apparatus in the encrypted RAG database, and perform a search on the stored homomorphically encrypted information when the query is obtained from the first electronic apparatus.

The encrypted RAG database may be shared among the at least one electronic apparatus.

The homomorphically encrypted information may include a homomorphically encrypted embedding vector, the instructions, when individually or collectively executed by the at least one processor, may cause the server apparatus to obtain response ciphertext corresponding to the homomorphically encrypted embedding vector identified through the search, and the response ciphertext may include encrypted text information.

According to another embodiment of the disclosure, an electronic apparatus includes: a communication circuit configured to communicate with a server apparatus including an encrypted retrieval-augmented generation (RAG) database; at least one processor including a processing circuitry; and a memory configured to store instructions, one or more storage media, and a neural network model, in which the instructions, when individually or collectively executed by the at least one processor, cause the electronic apparatus to transmit a query obtained based on user input to the encrypted RAG database of the server apparatus via the communication circuit, decrypt response ciphertext to obtain a prompt when obtaining the response ciphertext from the server apparatus, and input the prompt into the neural network model to generate response information.

The neural network model may be a small language model (SLM), a large language model (LLM), or a large multimodal model (LMM) executed within the electronic apparatus.

The instructions, when individually or collectively executed by the at least one processor, may cause the electronic apparatus to homomorphically encrypt at least one information stored in the electronic apparatus, and transmit the homomorphically encrypted information to the server apparatus via the communication circuit.

The instructions, when individually or collectively executed by the at least one processor, may cause the electronic apparatus to homomorphically encrypt the query obtained based on user input, and transmit the homomorphically encrypted query to the server apparatus via the communication circuit.

According to still another embodiment of the disclosure, a method of operating a server apparatus includes: searching an encrypted retrieval-augmented generation (RAG) database including at least one homomorphically encrypted information based on a query obtained from a first electronic apparatus among at least one electronic apparatus; obtaining response ciphertext based on the homomorphically encrypted information identified through the search; and transmitting the response ciphertext to the first electronic apparatus.

The query may be a homomorphically encrypted query, and the searching may include performing a homomorphic operation between the homomorphically encrypted query and the at least one homomorphically encrypted information to perform the search.

The method may further include: storing homomorphically encrypted information obtained from a second electronic apparatus among the at least one electronic apparatus in the encrypted RAG database; and performing a search on the stored homomorphically encrypted information when the query is obtained from the first electronic apparatus.

The homomorphically encrypted information may include a homomorphically encrypted embedding vector, the obtaining of the response ciphertext may include obtaining the response ciphertext corresponding to the homomorphically encrypted embedding vector identified through the search, and the response ciphertext may include encrypted text information.

The response ciphertext may be decrypted in the first electronic apparatus and input to a neural network model stored in the first electronic apparatus.

### BRIEF DESCRIPTION OF THE DRAWING FIGURES

The above-described contents and other aspects, features, and effects of embodiments of the present disclosure will become more apparent from the following description taken in conjunction with the accompanying drawings:

FIG. 1 is a diagram for describing a structure of a network system according to one or more embodiments of the present disclosure;

FIG. 2 is a block diagram illustrating a configuration of a server apparatus according to at least one embodiment of the present disclosure;

FIG. 3 is a sequence diagram for describing an operation of the server apparatus according to one or more embodiments of the present disclosure;

FIG. 4 is a flowchart for describing a method of obtaining response ciphertext according to one or more embodiments of the present disclosure;

FIG. 5 is a flowchart for describing a method of storing homomorphically encrypted information according to one or more embodiments of the present disclosure;

FIG. 6 is a flowchart for describing a method of obtaining response ciphertext according to one or more embodiments of the present disclosure;

FIG. 7 is a block diagram illustrating a configuration of an electronic apparatus according to at least one embodiment of the present disclosure;

FIG. 8 is a flowchart for describing a method of transmitting homomorphically encrypted information to a server apparatus according to one or more embodiments of the present disclosure;

FIG. 9 is a flowchart for describing a method of homomorphically encrypting a query obtained based on user input according to one or more embodiments of the present disclosure; and

FIG. 10 is a sequence diagram for describing a system including a server apparatus and an electronic apparatus according to one or more embodiments of the present disclosure.

### DETAILED DESCRIPTION OF THE EXEMPLARY EMBODIMENTS

Hereinafter, the present disclosure will be described in detail with reference to the accompanying drawings. Encryption/decryption may be applied to an information (data) transmission process performed in the present disclosure, if necessary, and all expressions describing the information (data) transmission process in the present disclosure and claims should be interpreted as including cases of encryption/decryption even if not separately stated. In the present disclosure, expressions such as “transmission (delivery) from A to B” or “A receiving from B” include transmission (delivery) or reception with another medium included therebetween, and does not necessarily express only what is directly transmitted (delivered) or received from A to B.

In the description of the present disclosure, the order of each step should be understood as non-limiting unless the preceding step needs to be logically and temporally performed necessarily before the following step. In other words, except for the above exceptional cases, even if the process described as the following step is performed before the process described as the preceding step, the nature of the disclosure is not affected, and the scope should also be defined regardless of the order of the steps. In this specification, “A or B” is defined to mean not only selectively indicating either one of A and B, but also including both A and B. In addition, in the present disclosure, the term “include” has a meaning encompassing further including other components in addition to elements listed as included.

In this disclosure, only essential components necessary for the description of the present disclosure are described, and components unrelated to the essence of the present disclosure are not mentioned. In addition, it should not be interpreted as an exclusive meaning that includes only the mentioned components, but should be interpreted as a non-exclusive meaning that may include other components.

In addition, in the present disclosure, “value” is defined as a concept including a vector as well as a scalar value. In the present disclosure, the expressions such as “compute,” and “calculate” may be replaced by an expression that produces a result of the corresponding computation or calculation. In addition, unless otherwise stated, an operation on ciphertext to be described below means a homomorphic calculation. For example, an addition of a homomorphic ciphertext means a homomorphic addition of two homomorphic ciphertexts.

Mathematical operations and calculations of each step of the present disclosure to be described below may be implemented as computer operations by the known coding method and/or coding designed to suit the present disclosure.

Specific equations to be described below are illustratively described among possible alternatives, and the scope of the present disclosure should not be construed as being limited to equations mentioned in the present disclosure.

For convenience of description, in the present disclosure, a notation is defined as follows.
a←D: Select element (a) according to distribution (D)
s1, s2∈R: Each of S1 and S2 is an element belonging to set R.
mod(q): Modular operation with respect to q
└⋅┐: Round-off internal value

Hereinafter, various embodiments of the present disclosure will be described in detail with reference to the accompanying drawings.

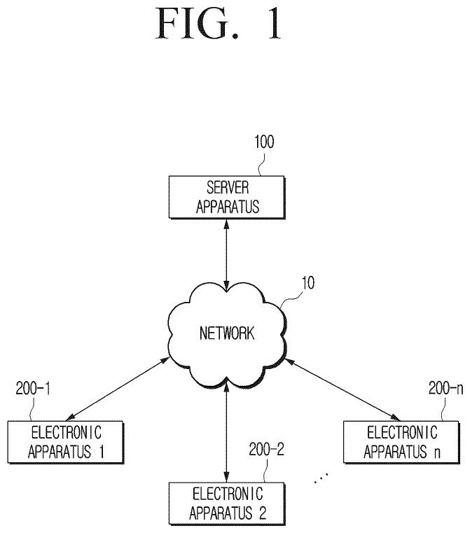

FIG. 1 is a diagram for describing a structure of a network system according to one or more embodiments of the present disclosure.

Referring to FIG. 1, the network system may include a server apparatus 100 and multiple electronic apparatuses 200-1 to 200-n, each of which may be interconnected via a network 10.

The network 10 may be implemented as various types of wired/wireless communication networks, broadcast communication networks, optical communication networks, cloud networks, etc. FIG. 1 illustrates the apparatuses 100 and 200-1 to 200-n as being indirectly connected to each other via the network 10, but the present disclosure is not limited thereto. Each apparatus may also be connected via Wi-Fi, Bluetooth, near field communication (NFC), etc., without a separate intermediary.

The server apparatus 100 is an apparatus configured to perform various types of processing, such as storing homomorphic ciphertext and performing operations on the homomorphic ciphertext. The server apparatus 100 may be implemented as a single electronic apparatus or as a cloud server. Furthermore, the server apparatus 100 may be implemented as a web server accessible via the Internet, etc.

In FIG. 1, the server apparatus 100 is shown separately from the electronic apparatuses 200-1 to 200-n for distinction. From another perspective, the server apparatus 100 may also be described as an electronic apparatus. In this case, the other electronic apparatuses 200-1 to 200-n may be described as external apparatuses.

The electronic apparatuses 200-1 to 200-n may be various terminal devices used by users. Specifically, the electronic apparatuses 200-1 to 200-n may be implemented in various forms, such as PCs, laptop PCs, smartphones, tablet PCs, game players, home servers, and kiosks. In addition, the electronic apparatuses 200-1 to 200-n may also be implemented in the form of home appliances with IoT functionality or as other server apparatuses. For example, the electronic apparatuses 200-1 to 200-n may be various terminal apparatuses used by the same user.

The electronic apparatuses 200-1 to 200-n may generate various keys (e.g., secret keys, public keys, and operation keys) related to the processing the homomorphic ciphertext. Using the generated public keys, the electronic apparatuses 200-1 to 200-n may convert a plaintext message into the homomorphic ciphertext, and then transmit the homomorphic ciphertext to the server apparatus 100.

Here, the homomorphic ciphertext refers to a ciphertext generated by encrypting plaintext data (e.g., vector values) using a homomorphic encryption method. Decrypting the operation results in the ciphertext state may obtain values corresponding to the corresponding results of operation in the plaintext state.

Furthermore, the homomorphic encryption refers to an encryption method that converts plaintexts into ciphertexts, ensuring that a specific operation on the ciphertexts matches the corresponding results of operation on the plaintexts. For example, the homomorphic encryption may be referred to as Cheon-Kim-Kim-Song (CKKS) encryption, homomorphic encryption (HE), etc.

The secret key refers to a private key used to decrypt the homomorphic ciphertext. The public key is a key generated in response to the above-described secret key and is used to generate the homomorphic ciphertext. An operation key is an evaluation key used to perform the homomorphic operations, such as rotation and relinearization, on the homomorphic ciphertext.

Users may input various types of information through the electronic apparatuses 200-1 to 200-n they use. The input information may be stored in the electronic apparatuses 200-1 to 200-n themselves, but may also be transmitted to and stored in an external apparatus (e.g., the server apparatus 100, etc., of FIG. 1) for reasons such as storage capacity and security. During the transmission to the external apparatus, data may be leaked to a third party, or an administrator of the external apparatus, etc., may directly confirm the corresponding data or leak the corresponding data to the outside. Therefore, data requiring security, such as a user's personal information, needs to be encrypted and converted into a form that may not be accessed or identified by third parties, and then provided to an external apparatus.

Accordingly, each electronic apparatus 200-1 to 200-n may homomorphically encrypt a plaintext message, convert the homomorphically encrypted plaintext message into homomorphic ciphertext, and then transmit the homomorphic ciphertext to the server apparatus 100.

Each of electronic apparatuses 200-1 to 200-n may include encryption noise, i.e., errors, generated during the homomorphic encryption process in the homomorphic ciphertext. For example, the homomorphic ciphertext generated by each of electronic apparatuses 200-1 to 200-n may be generated in a form that, when decrypted using a secret key, restores the result value, including the message and error value. This type of homomorphic encryption method that includes error values may be referred to as the CKKS scheme (or CKKS ciphertext).

For example, when the homomorphic ciphertexts generated by the electronic devices 200-1 to 200-n are decrypted using a secret key, the homomorphic ciphertexts may be generated in a form that satisfies the following natures.

$$Dec ( ct , sk ) = 〈 ct , sk 〉 = M + e ( mod q ) \qquad [ Equation 1 ]$$

Here, <, > represent an inner product. ct denotes a ciphertext, sk denotes a secret key, M denotes a plaintext message, e denotes an encryption error value, and mod q denotes a modulus of ciphertext. q should be selected to be greater than a result value obtained by multiplying a scaling factor Δ by a message. When an absolute value of the error value e is sufficiently small compared to M, the decrypted value M+e of the ciphertext is a value that may substitute for the original message with the same precision in terms of precision/approximate precision. Among the decrypted data, an error may be arranged on the least significant bit (LSB) side, and M may be arranged on the next least significant bit side.

Here, the scaling factor refers to a scale value applied to map real number or fixed-point values to a plaintext space of the homomorphic encryption. For example, after multiplying an input value by a scaling factor, the input value may be quantized and encoded as plaintext. Since the scale may change when performing homomorphic encryption operations (especially multiplication), the scaling factor may be used in the normalization or adjustment process to maintain decoding accuracy after the operation.

Each of electronic apparatuses 200-1 to 200-n may adjust a size of a message using the scaling factor if the size of the message is too small or too large. When the scaling factor is used, not only an integer type message but also a real number type message may be encrypted, and thus, the usability of the message may be greatly increased. In addition, by adjusting the size of the message using the scaling factor, a size of an area where messages exist in the ciphertext after the operation is made, that is, a size of an effective area may also be adjusted.

Depending on the embodiment, a modulus q of the ciphertext may be set and used in various forms. For example, the modulus of the ciphertext may be set in the form of q=Δ^{L} which is an exponent of the scaling factor Δ. When Δ is 2, Δ may be set to a value such as q=2¹⁰.

In addition, the homomorphic ciphertext according to the present disclosure is described on the assumption that a fixed point is used, but may be applied even when a floating point is used.

The server apparatus 100 may store the homomorphic ciphertexts transmitted from each of electronic apparatuses 200-1 to 200-n. In this state, the server apparatus 100 may perform the operations on the stored homomorphic ciphertexts upon a user request or upon the occurrence of a specific event.

For example, when the user of the first electronic apparatus 200-1 of FIG. 1 requests an operation result for a specific homomorphic ciphertext, the server apparatus 100 may perform the homomorphic operation on the corresponding homomorphic ciphertext in an encrypted state and transmit the homomorphically operated ciphertext (i.e., the operation result) to the first electronic apparatus 200-1. The first electronic apparatus 200-1 may decrypt the operation result using the secret key and provide the user with the decrypted plaintext.

Here, the homomorphic operation refers to an operation performed in the ciphertext state. For example, the homomorphic operation may include operations performed during the evaluation process, such as addition, multiplication, rotation, and relinearization.

Such homomorphic operations may be applied equally even during the search process. For example, the server apparatus 100 may perform an operation that responds to a query input from the electronic apparatuses 200-1 to 200-n.

Here, a “query” refers to query information generated based on the user input and used to request a similarity/distance evaluation with data (e.g., vector ciphertext) stored by the server apparatus. For example, the electronic apparatus may apply an embedding model to user input (e.g., natural language text) to generate a query vector and transmit the generated query vector to the server apparatus in plaintext or in a homomorphically encrypted state (Enc(q)). Furthermore, the “query search” may refer to a process in which a server apparatus searches, among stored data (e.g., homomorphic ciphertexts of data vectors), for data similar to a query (e.g., nearest neighbors) with respect to the query (e.g., a query vector) transmitted from the electronic apparatus. For example, the server apparatus 100 may generate the response ciphertext corresponding to the similarity (or distance) between the query and the stored homomorphic ciphertexts and transmit the generated response ciphertext to the electronic apparatus. The electronic apparatus may then decrypt the response ciphertext to obtain the search results.

The “homomorphic ciphertext” may refer to ciphertext obtained by encrypting data (e.g., vector values) using the homomorphic encryption method. The corresponding vector value may be plaintext value.

When the query is input, the server apparatus 100 may perform the homomorphic operation in the homomorphic ciphertext state, even without decrypting the vector values within the homomorphic ciphertext, to yield values necessary for calculating the similarity (or distance) with the query.

Meanwhile, the electronic apparatuses 200-1 to 200-n may utilize personalized data to provide AI services to users. For example, the electronic apparatuses 200-1 to 200-n may locally store the user's personal data (e.g., calendars, notes, contacts, documents, photo captions, etc.) and generate personalized responses based on the stored personal data through a neural network model (e.g., small language model (SLM), large language model (LLM), or large multimodal model (LMM)). In this case, privacy may be protected because personal data is not transmitted to an external server.

While the AI services utilizing the personalized data in this way have the advantage of providing personalized responses, they have also encountered the following challenges.

First, a method of processing personalized data on-device to protect privacy has difficulty in scaling to a multi-device environment. For example, personal data (e.g., schedules, memos, photo captions, etc.) generated by a user on a smartphone may be used for AI services only within the smartphone, and it has been difficult for the same user to receive the personalized AI services utilizing the corresponding data on a tablet or a laptop.

Second, to support a multi-device environment, storing personalized data on a cloud server has posed a problem in that it entails a risk of privacy exposure. When personal data is stored in plaintext on the cloud server, personal information may leak by a server administrator or an external attacker, which undermines user trust.

In particular, in retrieval-augmented generation (RAG)-based AI services, users' personal data should be stored in a database in the form of embedding vectors and original text, making privacy protection in a cloud environment an increasingly important challenge.

To address these issues, the present disclosure provides a technology that provides personalized AI services in a multi-device environment while preserving the privacy by storing the homomorphically encrypted RAG database on the cloud server and performing the search in the ciphertext state through the homomorphic operation.

In one or more embodiments, the server apparatus 100 may receive the homomorphically encrypted information (e.g., homomorphically encrypted embedding vectors and encrypted text information) from at least one electronic apparatus and store the homomorphically encrypted information in the encrypted RAG database. In this case, the encrypted RAG database may be shared among the plurality of electronic apparatuses, so a user may use personalized AI services on any electronic apparatus regardless of the apparatus that generates data.

When the server apparatus 100 receives the query (e.g., the homomorphically encrypted query) from the electronic apparatus 200, the server apparatus 100 may perform the homomorphic operation on the homomorphically encrypted information stored in the encrypted RAG database to perform the search, generate the response ciphertext based on the search result, and transmit the generated response ciphertext to the electronic apparatus 200. The electronic apparatus 200 may decrypt the received response ciphertext to obtain a prompt and input the prompt to a locally stored neural network model (e.g., an SLM or LLM) to generate the response information.

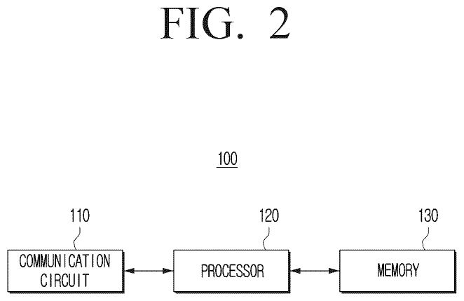

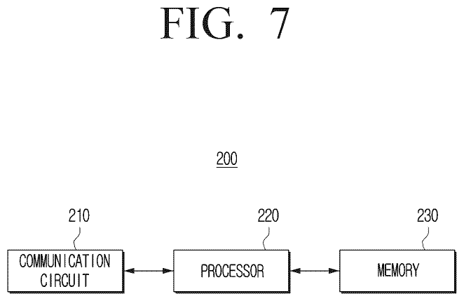

With this operation, the network system according to the present disclosure may perform the cloud-based RAG search without the server accessing the personal data in the plaintext state. Furthermore, the present disclosure enables consistent personalized AI services in the multi-device environment by storing the homomorphically encrypted information in the encrypted RAG database shared among the plurality of electronic apparatuses. The specific configuration of the server apparatus 100 according to the present disclosure will be described below with reference to FIG. 2. The specific configuration of the electronic apparatus 200 according to the present disclosure will be described below with reference to FIG. 7.

FIG. 2 is a block diagram illustrating a configuration of a server apparatus according to at least one embodiment of the present disclosure.

According to FIG. 2, the server apparatus 100 includes a communication circuit 110, a processor 120, and a memory 130.

The communication circuit 110 is a component for communicating with various external apparatuses, including an electronic apparatus (e.g., the electronic apparatus 200 of FIG. 7).

The communication circuit 110 may transmit and receive various signals and data to and from external devices through various wired and wireless communication methods, such as wired/wireless local area network (LAN), wide area network (WAN), Ethernet, IEEE 1394, Bluetooth, AP-based Wi-Fi (wireless LAN network), Zigbee, high-definition multimedia interface (HDMI), universal serial bus (USB), mobile high-definition link (MHL), audio engineering society/European broadcasting union (AES/EBU), optical, and coaxial.

For example, the communication circuit 110 may receive homomorphic ciphertext, various keys, operation requests, query requests, etc., from each electronic apparatus 200-1 to 200-n of FIG. 1, and may transmit the operation results of operating the homomorphic ciphertext, the query results (response ciphertext), etc., to each electronic apparatus 200-1 to 200-n.

The processor 120 is a component for controlling a general operation of the server apparatus 100. The processor 120 may perform various operations based on commands, programs, data, etc., stored in the memory 130.

The processor 120 may be implemented by a digital signal processor (DSP) or a microprocessor, that processes a digital signal. However, the processor 120 is not limited thereto, but may include one or more of a central processing unit (CPU), a micro controller unit (MCU), a micro processing unit (MPU), a controller, an application processor (AP), a communication processor (CP), and an ARM processor, a graphic processing unit (GPU), a neural processing unit (NPU), or an artificial intelligence (AI) processor, or may be defined by these terms. In addition, the processor 120 may be implemented by a system-on-chip (SoC) or a large scale integration (LSI) in which a processing algorithm is embedded, or may be implemented in the form of a field programmable gate array (FPGA).

The CPU is a general-purpose processor capable of performing not only general operations but also artificial intelligence operations, and may efficiently execute complex programs through a multi-layer cache structure. The CPU is advantageous in a serial processing method that enables organic linking of previous and subsequent operation results through sequential calculations.

The GPU is the processor for large-scale computations, such as floating-point operations used in graphics processing, and integrates a large number of cores to perform large-scale computations in parallel. In particular, the GPU may be advantageous over CPUs for parallel processing methods, such as convolution operations. Furthermore, the GPU may be used as coprocessors to supplement the functions of the CPU.

The NPU is the processor specialized for artificial intelligence computations using the artificial neural network, and may implement each layer of the artificial neural network in hardware (e.g., silicon). In this case, since the NPU is designed to be specialized according to the specifications required by the manufacturer, the NPU has less flexibility compared to the CPU or GPU, but may efficiently process the artificial intelligence operations required by the manufacturer. The NPU is the processor specialized for the artificial intelligence operations, and may be implemented in various forms, such as a tensor processing unit (TPU), an intelligence processing unit (IPU), and a vision processing unit (VPU). Except where specifically referred to as the NPU described above, the AI processor is not limited to the examples described above.

In addition, the processor 120 may be implemented as a system on chip (SoC). In this case, the SoC may be equipped not only with one or more processors 120 but also with the memory 130, and may further include a bus for data communication between the memory 130 and the processor(s) 120.

The memory 130 is configured to store various programs, data, instructions, etc. required for the operation of the server apparatus 100. The memory 130 may be implemented as at least one of various memories, such as dynamic RAM, static RAM (SRAM), synchronous dynamic RAM (SDRAM), one-time programmable ROM (OTPROM), programmable ROM (PROM), erasable and programmable ROM (EPROM), electrically erasable and programmable ROM (EEPROM), mask ROM, flash ROM, flash memory, a hard drive, or a solid state drive (SSD).

The memory 130 may store various homomorphic ciphertexts received via the communication circuit 110, as well as operation keys, switching keys, public keys, etc., used in their operations. Furthermore, the memory 130 may store various mathematical formulas, instructions, etc., required to generate the secret and public keys.

The memory 130 may also store at least one artificial intelligence model capable of processing the homomorphic ciphertext, as well as the data and programs for training the model.

Here, the embedding space refers to a vector space where data is expressed and positioned in the vector form, and the nearest neighbor search may be performed in this space based on a distance or similarity measure. Such an embedding space may also be referred to as a feature space, a vector space, a representation space, etc.

When an operation request is received from the electronic apparatus (e.g., electronic apparatus 200) via the communication circuit 110 or a predetermined event occurs, the processor 120 may perform the operation on at least one homomorphic ciphertext stored in the memory 130 and provide the operation results to the electronic apparatus in the homomorphically encrypted form.

Here, the predetermined event may include a case where a predetermined time period arrives, new homomorphic ciphertext is received and stored, an update to previously stored homomorphic ciphertext is performed, etc. For example, when a user requests confirmation of registration of the homomorphic ciphertext for personal information while transmitting the personal information, the processor 120 may perform an inner product operation between the pre-stored homomorphic ciphertexts and the received homomorphic ciphertext, and then an operation of collating the operation results and transmitting the collated operation results to the electronic apparatus. Furthermore, the types of operations performed on the homomorphic ciphertext may vary depending on the user's request.

When the operation results are transmitted to the electronic apparatus, the electronic apparatus may decrypt the operation results and provide the operation results to the user.

According to one or more embodiments, the processor 120 may search the encrypted RAG database.

In one example, the processor 120 may search the encrypted RAG database based on a query obtained from a first electronic apparatus among at least one electronic apparatus (e.g., the plurality of electronic apparatuses 200-1 to 200-n of FIG. 1) via the communication circuit 110. In one example, the query may be generated based on the user input and may be query information for requesting a similarity evaluation with the homomorphically encrypted information stored in the encrypted RAG database.

The homomorphically encrypted information may refer to information generated by encrypting the plaintext data using the homomorphic encryption method. In one example, the homomorphically encrypted information may include a homomorphically encrypted embedding vector. For example, the electronic apparatuses, such as mobile phones and laptops, may homomorphically encrypt data to generate homomorphically encrypted information and store the generated homomorphically encrypted information in the server apparatus.

The encrypted RAG database may refer to a database that stores the homomorphically encrypted information for the retrieval-augmented generation. The retrieval-augmented generation (RAG) refers to a method of retrieving relevant information from an external database and utilizing the retrieved relevant information to generate responses from a language model.

In one example, the encrypted RAG database may be implemented on the cloud server and store the homomorphically encrypted information obtained from the plurality of electronic apparatuses. For example, the encrypted RAG database may store the homomorphically encrypted embedding vector and the data (e.g., original text) corresponding to the corresponding embedding vector.

For example, the encrypted RAG database may be shared among the plurality of electronic apparatuses to support the search in the multi-device environment. The electronic apparatus may download search results from the encrypted RAG database and decrypt the search results to obtain prompts.

In one example, the processor 120 may perform a search by performing the homomorphic operation between the query and at least one homomorphically encrypted information stored in the encrypted RAG database. In one example, the processor 120 may perform the homomorphic operation on the query and the homomorphically encrypted information in the ciphertext state in which the query and the homomorphically encrypted information are not decrypted.

For example, the processor 120 may perform the inner product operation between the query and the homomorphically encrypted embedding vector as a homomorphic operation to calculate a similarity value. In one example, the processor 120 may perform a distance operation (e.g., Euclidean distance, cosine distance, etc.) between the query and the homomorphically encrypted embedding vector as the homomorphic operation. Based on the calculated similarity value, the processor 120 may identify at least one homomorphically encrypted information most similar to the query among the homomorphically encrypted information stored in the encrypted RAG database.

According to one or more embodiments, the processor 120 may obtain the response ciphertext.

In one example, the processor 120 may obtain the response ciphertext based on the homomorphically encrypted information identified through the search. In one example, the response ciphertext may be encrypted information for generating a prompt that is decrypted by the first electronic apparatus and input to the neural network model. The response ciphertext may refer to information that includes the search results for the query in the ciphertext form.

In one example, the response ciphertext may include the homomorphically encrypted embedding vector. Alternatively, in one example, the response ciphertext may include at least one of the homomorphically encrypted information and the corresponding encrypted original data.

In one example, the processor 120 may generate the response ciphertext based on the homomorphic operation results. For example, the processor 120 may identify the homomorphically encrypted information corresponding to the highest similarity value between each homomorphically encrypted information and the query, and obtain the ciphertext associated with the identified homomorphically encrypted information as the response ciphertext.

In one example, the processor 120 may identify multiple homomorphically encrypted information with similarity values greater than or equal to a predetermined threshold, and obtain the ciphertexts associated with each of the identified homomorphically encrypted information as the response ciphertext.

In one example, the processor 120 may obtain the response ciphertext as is without decrypting the homomorphic operation result. For example, the processor 120 may obtain encrypted text information corresponding to the identified homomorphic encrypted embedding vector as the response ciphertext. The encrypted text information may be ciphertext of original text data stored in the encrypted RAG database, associated with the homomorphically encrypted embedding vector.

For example, the processor 120 may use the homomorphically encrypted embedding vector as an index key in the encrypted RAG database to obtain the encrypted text information corresponding to the corresponding index key as the response ciphertext.

According to one or more embodiments, the processor 120 may transmit the response ciphertext to the first electronic apparatus.

In one example, the processor 120 may transmit the obtained response ciphertext to the first electronic apparatus via the communication circuit 110. In one example, the first electronic apparatus may refer to an electronic apparatus (e.g., electronic apparatus 200) that transmits the query to the server apparatus 100 among at least one electronic apparatus communicating with the server apparatus 100.

In one example, the processor 120 may transmit the response ciphertext to the first electronic apparatus (e.g., the electronic apparatus 200) via a network (e.g., the network 10 of FIG. 1). For example, the processor 120 may transmit the response ciphertext to the first electronic apparatus via a wired or wireless communication network, a broadcast communication network, an optical communication network, or a cloud network. For example, the processor 120 may transmit the response ciphertext to the first electronic apparatus via Wi-Fi, Bluetooth, or near field communication (NFC).

In one example, the first electronic apparatus may decrypt the received response ciphertext using the secret key to obtain a prompt. The prompt may be plaintext information obtained by decrypting the response ciphertext and may be input data for generating response information by being input to a neural network model. For example, the first electronic apparatus may input the obtained prompt to a locally stored neural network model (e.g., small language model (SLM), large language model (LLM), or large multimodal model (LMM)) to generate the response information corresponding to the user query.

According to the above-described example, the server apparatus 100 performs the homomorphic operation to search the encrypted RAG database without decrypting the homomorphically encrypted information, thereby providing the AI services based on the retrieval-augmented generation while preserving the privacy of the user's personalized data.

Furthermore, according to the above-described example, the server apparatus 100 implements the encrypted RAG database on the cloud server and shares the encrypted RAG database among the plurality of electronic apparatuses, thereby providing the consistent personalized AI service experience in the multi-device environment, such as a mobile phone or a laptop.

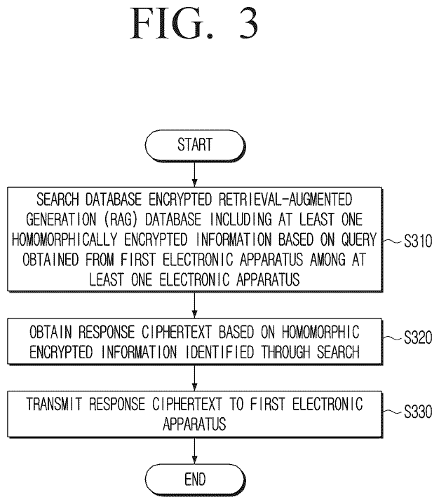

FIG. 3 is a sequence diagram for describing an operation of the server device according to one or more embodiments of the present disclosure.

Referring to FIG. 3, according to one or more embodiments, the operating method may include an operation (S310) of searching an encrypted retrieval-augmented generation (RAG) database including at least one homomorphically encrypted information based on the query obtained from the first electronic apparatus among at least one electronic apparatus (e.g., the plurality of electronic apparatuses 200-1 to 200-n of FIG. 1).

In one example, the server apparatus 100 may obtain the query from the first electronic apparatus via the communication circuit. The server apparatus 100 may perform the search on the encrypted RAG database based on the obtained query.

For example, when the query is the homomorphically encrypted query, the server apparatus 100 may perform the homomorphic operation between the homomorphically encrypted query and the homomorphically encrypted information stored in the encrypted RAG database to perform the search. For example, the server apparatus 100 may calculate the similarity value between the query and the homomorphically encrypted information through the homomorphic operation. Based on the calculated similarity value, the server apparatus 100 may identify the homomorphically encrypted information related to the query.

According to one or more embodiments, the operating method may include an operation (S320) of obtaining the response ciphertext based on the homomorphically encrypted information identified through the search. In one example, the server apparatus 100 may obtain the response ciphertext based on the homomorphically encrypted information identified through the search.

According to one or more embodiments, the operating method may include an operation (S330) of transmitting the response ciphertext to the first electronic apparatus. In one example, the server apparatus 100 may transmit the response ciphertext to the first electronic apparatus.

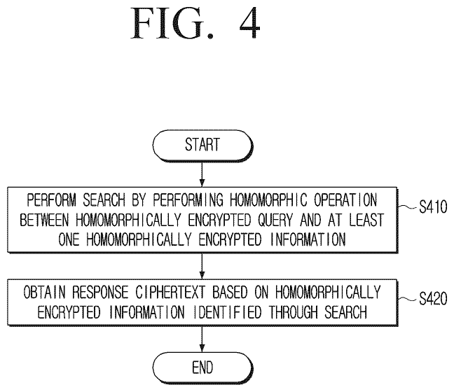

FIG. 4 is a flowchart for describing a method of obtaining response ciphertext according to one or more embodiments of the present disclosure.

Referring to FIG. 4, according to one or more embodiments, the operating method may include an operation (S410) of performing a search by performing the homomorphic operation between the homomorphically encrypted query and at least one homomorphically encrypted information.

In one example, the server apparatus 100 may perform the search by performing the homomorphic operation between the homomorphically encrypted query and at least one homomorphically encrypted information. The homomorphically encrypted query may refer to a query generated by encrypting a query in plaintext (e.g., an embedding vector) using a homomorphic encryption method.

In one example, the server apparatus 100 may perform the search by performing the homomorphic operation between the homomorphically encrypted query and at least one homomorphically encrypted information. The server apparatus 100 may perform the homomorphic operation without decrypting the homomorphically encrypted query and the homomorphically encrypted information.

For example, the server apparatus 100 may perform the inner product operation between the homomorphically encrypted query and the homomorphically encrypted information as the homomorphic operation to calculate the similarity value. For example, the server apparatus 100 may perform the distance operation between the homomorphically encrypted query and the homomorphically encrypted information as the homomorphic operation.

According to one or more embodiments, the operating method may include an operation (S420) of obtaining the response ciphertext based on the homomorphically encrypted information identified through the search. In one example, the server apparatus 100 may obtain the response ciphertext based on the homomorphically encrypted information identified through the search.

In one example, the server apparatus 100 may obtain the response ciphertext based on the homomorphically encrypted information identified through the search. The server apparatus 100 may generate the response ciphertext based on the homomorphic operation results. The server apparatus 100 may transmit the obtained response ciphertext to the first electronic apparatus via the communication circuit.

For example, the server apparatus 100 may obtain, as the response ciphertext, the ciphertext corresponding to the highest similarity value among the similarity values between each homomorphically encrypted information and the homomorphically encrypted query. The server apparatus 100 may obtain the response ciphertext in its original ciphertext state without decrypting the homomorphic operation result. The server apparatus 100 may transmit the obtained response ciphertext to the first electronic apparatus via the communication circuit.

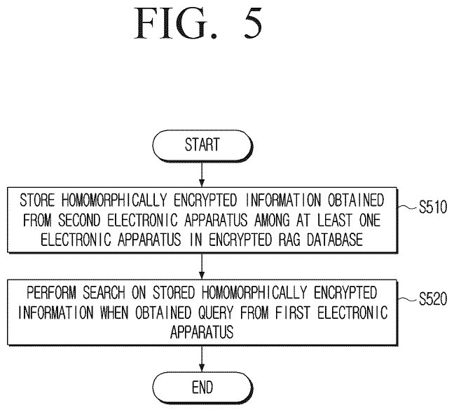

FIG. 5 is a flowchart for describing a method of storing homomorphically encrypted information according to one or more embodiments of the present disclosure.

Referring to FIG. 5, according to one or more embodiments, the operating method may include an operation (S510) of storing homomorphically encrypted information obtained from a second electronic apparatus among at least one electronic apparatus in the encrypted RAG database.

According to an example, the server apparatus 100 may store the homomorphically encrypted information obtained from different types of electronic apparatuses, including the second electronic apparatus, among at least one electronic apparatus in the encrypted RAG database. The second electronic apparatus may refer to an electronic apparatus that transmits the homomorphically encrypted information to the server apparatus 100, among at least one electronic apparatus that communicates with the server apparatus 100. The server apparatus 100 may receive the homomorphically encrypted information from different types of electronic apparatuses, including the second electronic apparatus, via a communication circuit.

For example, the server apparatus 100 may obtain the homomorphically encrypted embedding vectors from different types of electronic apparatuses, including the second electronic apparatus, and store the homomorphically encrypted embedding vectors in the encrypted RAG database. The server apparatus 100 may receive the homomorphically encrypted information and corresponding data (e.g., original text) from different types of electronic apparatuses, including a second electronic apparatus. The server apparatus 100 may store the received homomorphically encrypted information and the associated data in the encrypted RAG database.

For example, the second electronic apparatus may be a terminal apparatus of the same user as the first user of the first electronic apparatus. When the first user generates personal data, such as a personal memo, schedule, contact information, or caption text for a photo, on the second electronic apparatus, the second electronic apparatus may homomorphically encrypt personal data and transmit the homomorphically encrypted personal data to the server apparatus 100.

Specifically, the second electronic apparatus may apply an embedding model to first user's personal data to generate an embedding vector. For example, the second electronic apparatus may apply an embedding model to schedule data such as “Meeting with Manager A on Mar. 15, 2025” to generate an embedding vector. The second electronic apparatus may homomorphically encrypt the generated embedding vector and transmit the homomorphically encrypted embedding data to the server apparatus 100. The server apparatus 100 may store the homomorphically encrypted embedding vector in the RAG database.

Meanwhile, as an example, the second electronic apparatus may encrypt original text data corresponding to the embedding vectors and transmit the encrypted original text data to the server apparatus 100 along with the homomorphically encrypted embedding vectors. For example, the second electronic apparatus may transmit encrypted text information corresponding to “Meeting with Manager A on Mar. 15, 2025” along with the homomorphically encrypted embedding vector to the server apparatus 100.

In an example, the server apparatus 100 may associate the homomorphically encrypted embedding vectors and encrypted text information received from different types of electronic apparatus, including the second electronic device, and store the associated information in the encrypted RAG database. In an example, the server apparatus 100 may use homomorphically encrypted embedding vector as an index key and store encrypted text information as a value corresponding to the index key.

According to one or more embodiments, the operating method may include performing a search operation (S520) on the stored homomorphically encrypted information upon receiving the query from the first electronic apparatus.

In one example, the server apparatus 100 may perform a search for the stored homomorphically encrypted information upon receiving the query from the first electronic apparatus. The first electronic apparatus may refer to an electronic apparatus that transmits the query to the server apparatus 100 among at least one electronic apparatus that communicates with the server apparatus 100. In one example, the query transmitted to the server apparatus 100 may be a homomorphically encrypted query.

In one example, the server apparatus 100 may perform the search for the stored homomorphically encrypted information upon receiving the query from the first electronic apparatus. The server apparatus 100 may perform a search based on the query from the first electronic apparatus for the stored homomorphically encrypted information from different types of electronic apparatuses, including the second electronic apparatus.

For example, when the first electronic apparatus and the second electronic apparatus are associated with the same user account, the server apparatus 100 may search the homomorphically encrypted information stored by the second electronic apparatus using the query from the first electronic apparatus. By sharing the encrypted RAG database among the plurality of electronic apparatuses, the server apparatus 100 may perform the search for the same homomorphically encrypted information in the plurality of electronic apparatuses. The server apparatus 100 may support the search for the homomorphically encrypted information in the multi-device environment.

According to the above-described example, the server apparatus 100 receives the homomorphically encrypted information from different types of electronic apparatuses, including the second electronic apparatus, as the apparatuses of the same user, stores the homomorphically encrypted information in the encrypted RAG database, and performs the search for the stored homomorphically encrypted information based on the query from the first electronic apparatus, thereby allowing the server apparatus 100 to provide the consistent personalized AI services in the multi-device environment without exposing the user's personal data to the server in the plaintext state.

Furthermore, according to the above-described example, the server apparatus 100 associates the homomorphically encrypted embedding vectors and the encrypted text information obtained from the plurality of electronic apparatuses and stores the homomorphically encrypted embedding vectors and the encrypted text information in the encrypted RAG database, and shares the corresponding database among the plurality of electronic apparatuses, thereby enabling personal data generated from a specific electronic apparatus to be utilized on other electronic apparatuses while preserving privacy.

According to the above-described example, the server apparatus 100 supports searching the homomorphically encrypted information stored in other electronic apparatuses using the query from the first electronic apparatus, thereby enabling a user to utilize personalized information search and AI response generation services on any electronic apparatus, regardless of the apparatus used by the user to generate the data.

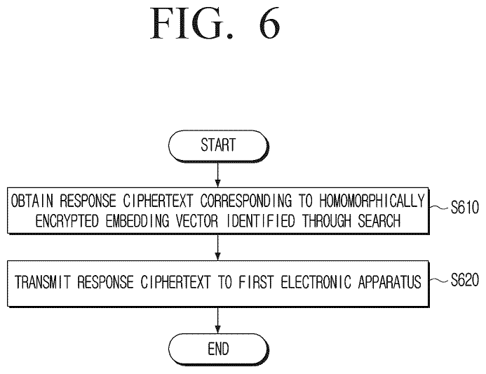

FIG. 6 is a flowchart for describing a method of obtaining response ciphertext according to one or more embodiments of the present disclosure.

According to FIG. 6, the method according to one or more embodiments may include an operation (S610) of obtaining the response ciphertext corresponding to the homomorphically encrypted embedding vector identified through the search.

In one example, the server apparatus 100 may identify the homomorphically encrypted embedding vector corresponding to the homomorphically encrypted query vector in the encrypted RAG database. For example, the server apparatus 100 may search information stored in the encrypted RAG database based on the query vector to identify the homomorphically encrypted embedding vector corresponding to the query vector in the RAG database. For example, the server apparatus 100 may identify an embedding vector having a relatively highest similarity value with the homomorphically encrypted query vector within the encrypted RAG database.

In one example, the server apparatus 100 may obtain the response ciphertext corresponding to the homomorphically encrypted embedding vector identified through the search. The homomorphically encrypted embedding vector may refer to a vector generated by encrypting a plaintext embedding vector using the homomorphic encryption method. For example, the server apparatus 100 may obtain, as the response ciphertext, encrypted text information corresponding to the homomorphically encrypted embedding vector identified as the search result. In other words, the server apparatus 100 may obtain the encrypted original text information as the response ciphertext.

Alternatively, for example, the server apparatus 100 may obtain, as the response ciphertext, at least one of the homomorphically encrypted embedding vector and the encrypted original text information identified as the search result.

According to one or more embodiments, the operating method may include an operation (S620) of transmitting the response ciphertext to the first electronic apparatus.

In one example, the server apparatus 100 may transmit the response ciphertext to the first electronic apparatus via the communication circuit. For example, the server apparatus 100 may transmit the response ciphertext including the encrypted text information to the first electronic apparatus. Alternatively, for example, the server apparatus 100 may transmit at least one of the homomorphically encrypted embedding vector and the encrypted text information identified as the search results to the first electronic apparatus.

In one example, the electronic apparatus may decrypt the response ciphertext to obtain the prompt. For example, the electronic apparatus may decrypt the information (e.g., original text information) obtained as the response ciphertext and input the decrypted information to the neural network model to generate the response information.

FIG. 7 is a block diagram illustrating a configuration of an electronic device according to at least one embodiment of the present disclosure.

According to FIG. 7, the electronic apparatus 200 includes a communication circuit 210, a processor 220, and a memory 230. In one example, the electronic apparatus 200 may be implemented as an apparatus that communicates with the server apparatus 100 (e.g., any one of the electronic apparatuses 200-1 to 200-n of FIG. 1).

The electronic apparatus 200 may be implemented in various types. For example, when the electronic apparatus 200 is implemented as an integrated apparatus with a display, such as a smartphone or tablet PC, the electronic apparatus 200 may include the communication circuit 210, the memory 220, the processor 230, and components such as a display and/or an input unit.

The general operations and examples of the communication circuit 210, the memory 220, and the processor 230 are identical or similar to those described for the server apparatus 100, and therefore, a duplicate description thereof will be omitted.

The communication circuit 210 may transmit the homomorphic ciphertext to the server apparatus 100.

The communication circuit 210 may transmit a query to the server apparatus 100. In this case, the query may be homomorphically encrypted and transmitted. In this case, the query may be referred to as the homomorphically encrypted query.

The communication circuit 210 may receive the response ciphertext corresponding to the query.

The memory 220 may store a secret key, a public key, etc., to be used in the electronic apparatus 200.

Although not illustrated in FIG. 7, the electronic apparatus 200 may include a display. The display is configured to display various user interface (UI) screens. As described above, when the operation results (or query results) for the homomorphic ciphertext transmitted from the server apparatus 100 is received via the communication circuit 210, the processor 230 decrypts the operation results using the secret key stored in the memory 220 and then displays the decrypted operation results on the display.

The input unit is configured to input various user commands. When the electronic apparatus 200 is implemented as a smartphone or tablet PC, the input unit may be implemented as a touch screen integrated into the display. However, the present disclosure is not limited thereto, and the input unit may also be implemented as a button or a touchpad. Alternatively, when the electronic apparatus 200 supports voice recognition, the input unit may include a microphone.

When a user inputs a user command requesting to store specific information in the server apparatus 100 via the input unit, the processor 230 may homomorphically encrypt the information.

The homomorphic encryption method may be implemented using various schemes. While various embodiments of the present disclosure describe the homomorphic encryption according to the Cheon-Kim-Kim-Song (CKKS) scheme, the present disclosure is not limited thereto, and various other schemes may be implemented.

To perform the homomorphic encryption, various keys, such as a public key and a secret key, are required. The processor 230 or the processor 120 may generate these keys directly or receive and use the generated keys from an external apparatus. Hereinafter, to facilitate description, the general key generation operation is described below, and then the query search operation according to the present disclosure will be described.

When the electronic apparatus 200 generates its own key, the processor 230 may generate the public key using a Ring-LWE technique. Describing in detail, the processor 230 may first set various parameters and rings and store the set parameters and rings in the memory 220. Examples of the parameters may include a length of a plaintext message bit, dimension n, rank k, sizes of public and secret keys, etc. There are various forms of homomorphic ciphertexts, and the processor 230 may configure a ring according to a ciphertext scheme set by a user or a predetermined scheme. For example, the homomorphic ciphertext scheme described above may be a CKKS scheme, an RLWE scheme, etc.

The ring may be represented by the following Equation 2.

$$R = {Z}_{q} [ X ] / f ( x ) \qquad [ Equation 2 ]$$

Here, R denotes a ring, Zq denotes a coefficient, and f(x) denotes an n-th polynomial.

The ring is a set of polynomials having predetermined coefficients, and means a set in which addition and multiplication are defined between elements and which is closed for addition and multiplication.

For example, the ring means a set of n-th polynomials having a coefficient Zq. Specifically, when n is Φ (N), it means an N-th cyclotomic polynomial. f(x) denotes ideal of Zq[x] generated by the f(x). The Euler totient function Φ(N) means the number of natural numbers that is coprime to N and smaller than N. When Φ_{N}(x) is defined as an N-th cyclotomic polynomial, the ring may also be represented by Equation 3 as follows.

$$R = {Z}_{q} [ X ] / ( Φ N ( x ) ) \qquad [ Equation 3 ]$$

The ring R of the above-described Equation 3 has complex numbers in the plaintext space.

In order to improve the operation speed of the homomorphic ciphertext, only a set in which the plaintext space is a real number in the above-described set of rings may be used.

When such a ring is established, the processor 230 may calculate the secret key sk from the ring. The secret key sk may be represented as follows.

$$s k ← ( 1 , s ( x ) ) , s ( x ) ∈ R \qquad [ Equation 4 ]$$

Here, s(x) means a polynomial generated randomly with small coefficients. Since the secret key sk may be composed of a polynomial of s, the secret key sk may also be referred to as s in the present disclosure.

The processor 230 calculates a first random polynomial a(x) from the ring. The first random polynomial may be represented as follows.

$$a ( x ) ← R \qquad [ Equation 5 ]$$

Also, the processor 230 may calculate an error. Specifically, the processor 230 may extract an error from a discrete Gaussian distribution or a distribution statistically close to the discrete Gaussian distribution. This error may be represented as follows.

$$e ( x ) ← D n α q \qquad [ Equation 6 ]$$

When an error is calculated, the processor 230 may calculate a second random polynomial by performing modular operation on the error in the first random polynomial and the secret key. The second random polynomial may be represented as follows.

$$b ( x ) = - a ( x ) s ( x ) + e ( x ) ( mod q ) \qquad [ Equation 7 ]$$

Finally, a public key pk is set as follows in a form including the first random polynomial and the second random polynomial.

$$p k = ( b ( x ) , a ( x ) ) \qquad [ Equation 8 ]$$

The contents of the above-described Equations 2 to 8 are examples of cases where the CKKS scheme (i.e., the RLWE scheme) is used. The above-described schemes may be modified to suit the corresponding scheme when the LWE or MLWE scheme is used. In addition, it is of course possible to generate the public and secret keys using schemes other than those described above.

According to one or more embodiments, the processor 220 may transmit the query to the server apparatus 100.

In one example, the processor 220 may transmit the query obtained based on the user input to the encrypted RAG database of the server apparatus 100 via the communication circuit 210. In one example, the user input may be natural language text or voice data input through an input interface (e.g., a touchscreen, keyboard, microphone, etc.) of the electronic apparatus 200.

In one example, the processor 220 may generate the query based on the user input. For example, the processor 220 may apply an embedding model to a user input (e.g., “Tell me my schedule for tomorrow”) to generate a query vector and obtain the generated query vector as a query. The embedding model may be a neural network model that maps natural language text to a fixed-dimensional vector space. For example, the processor 220 may generate a query vector using an embedding model stored locally in the electronic apparatus 200.

In one example, the processor 220 may homomorphically encrypt the query and transmit the homomorphically encrypted query to the server apparatus 100. For example, the processor 220 may homomorphically encrypt the generated query vector using the public key and transmit the homomorphically encrypted query to the server apparatus 100 via the communication circuit 210. For example, the processor 220 may homomorphically encrypt the query using the homomorphic encryption method such as the Cheon-Kim-Kim-Song (CKKS) scheme.

According to one or more embodiments, the processor 220 may obtain a prompt.

In one example, upon obtaining the response ciphertext from the server apparatus 100, the processor 220 may decrypt the response ciphertext to obtain the prompt. In one example, the response ciphertext may be ciphertext generated by the server apparatus 100 based on the homomorphically encrypted information identified by searching the encrypted RAG database.

In one example, the processor 220 may receive the response ciphertext from the server apparatus 100 via the communication circuit 210. For example, the processor 220 may receive the response ciphertext corresponding to the query from the server apparatus 100 via the network 10. For example, the response ciphertext may include the encrypted text information associated with the homomorphically encrypted embedding vector with high similarity to the query.

In one example, the processor 220 may decrypt the response ciphertext using the secret key. The secret key is a private key used to decrypt the homomorphic ciphertext, and may be stored in the electronic apparatus 200. For example, the processor 220 may apply the secret key to the response ciphertext to obtain the plaintext text information and use the obtained text information as a prompt. For example, the prompt may include contextual information generated based on the user's personal data (e.g., schedule, memos, document contents, etc.).

According to one or more embodiments, the processor 220 may generate the response information.

In one example, the processor 220 may input the prompt to the neural network model to generate the response information. In one example, the neural network model may be a language model executed within the electronic apparatus 200 that generates a response in natural language based on the prompt.

In one example, the processor 220 may generate the response information using the neural network model stored locally on the electronic apparatus 200. For example, the processor 220 may input the prompt to the small language model (SLM), the large language model (LLM), or the large multimodal model (LMM) to generate the response information corresponding to the user's query.

The SLM may be a lightweight language model that may be executed within the limited computational resources of the electronic apparatus 200. For example, the processor 220 may select at least one of the SLM and LLM to generate the response information based on the computational resources and response quality requirements of the electronic apparatus 200.

In one example, the processor 220 may combine the prompt and the user input and input the combined prompt and user input to the neural network model. For example, the processor 220 may combine a decrypted prompt (e.g., “I have a meeting with Manager A on Mar. 15, 2025”) and a user input (e.g., “Tell me my schedule for tomorrow”), input the combined decrypted prompt and user input to a neural network model, and generate personalized response information (e.g., “I have a meeting with Manager A tomorrow at 2 PM”) from the neural network model. As an example, the processor 220 may provide the generated response information to the user through an output apparatus (e.g., a display, a speaker, etc.) of the electronic apparatus 200.

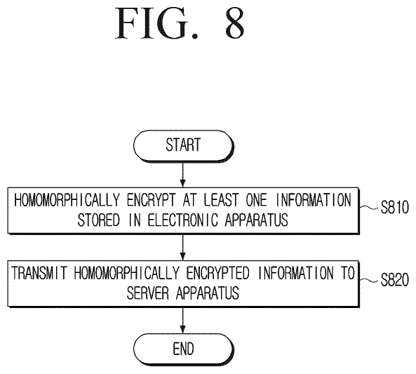

FIG. 8 is a flowchart for describing a method of transmitting homomorphically encrypted information to a server device according to one or more embodiments of the present disclosure.

Referring to FIG. 8, the operating method according to one or more embodiments may include an operation (S810) of homomorphically encrypting at least one information stored in the electronic apparatus. In one example, the electronic apparatus 200 may homomorphically encrypt at least one information stored in the electronic apparatus 200. In one example, at least one information may include user's personal data (e.g., a schedule, notes, contact information, documents, or the like).

In one example, the electronic apparatus 200 may apply an embedding model to the stored information to generate an embedding vector and homomorphically encrypt the generated embedding vector. For example, the electronic apparatus 200 may apply the embedding model to schedule data such as “Meeting with Manager A on Mar. 15, 2025” to generate the embedding vector.

In one example, the electronic apparatus 200 may homomorphically encrypt an embedding vector using a public key. The public key is a key generated in response to a secret key and may be used to convert plaintext data into homomorphic ciphertext. For example, the electronic apparatus 200 may homomorphically encrypt the embedding vector using the homomorphic encryption method.

In one example, the electronic apparatus 200 may encrypt the homomorphically encrypted embedding vector along with the original text data corresponding to the embedding vector.

According to one or more embodiments, the operating method may include an operation (S820) of transmitting the homomorphically encrypted information to the server apparatus. In one example, the electronic apparatus 200 may transmit the homomorphically encrypted information to the server apparatus 100. In one example, the homomorphically encrypted information may include at least one of the homomorphically encrypted embedding vector and the encrypted text information.

In one example, the electronic apparatus 200 may transmit the homomorphically encrypted information to the server apparatus 100 via the communication circuit 210. For example, the electronic apparatus 200 may transmit the homomorphically encrypted embedding vector and the encrypted text information to the server apparatus 100 via the network 10.

In one example, the server apparatus 100 may store the homomorphically encrypted information received from the electronic apparatus 200 in the encrypted RAG database. For example, the server apparatus 100 may use the homomorphically encrypted embedding vector as an index key and associate the encrypted text information with a value corresponding to the index key and store the encrypted text information in the encrypted RAG database. The encrypted RAG database may be shared among the plurality of electronic apparatuses 200-1 to 200-n, thereby allowing the homomorphically encrypted information stored in the electronic apparatus 200 to be searched through the query transmitted from other electronic apparatuses.

According to the above-described example, the electronic apparatus 200 may accumulate personalized information in a cloud-based encrypted RAG database by homomorphically encrypting stored information and transmitting the homomorphically encrypted information to the server apparatus 100, thereby preventing the user's personal data from being exposed to the server in the plaintext state.

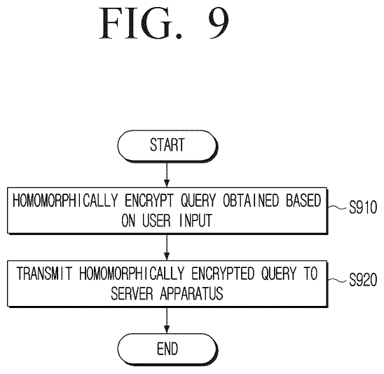

FIG. 9 is a flowchart for describing a method of homomorphically encrypting a query obtained based on user input according to one or more embodiments of the present disclosure.

Referring to FIG. 9, the operating method according to one or more embodiments may include an operation (S910) of homomorphically encrypting a query obtained based on user input. In one example, the electronic apparatus 200 may homomorphically encrypt the query obtained based on the user input.

In one example, the electronic apparatus 200 may obtain the query based on the user input. For example, the electronic apparatus 200 may apply an embedding model to a user input (e.g., “Tell me my schedule for tomorrow”) to generate a query vector and obtain the generated query vector as a query.

In one example, the electronic apparatus 200 may homomorphically encrypt a query using a public key. For example, the electronic apparatus 200 may homomorphically encrypt the query vector using the homomorphic encryption method. For example, the electronic apparatus 200 may include encryption noise generated during the homomorphic encryption process in the homomorphically encrypted query, and the noise may be controlled to a level that does not affect the accuracy of the original query vector during decryption.

According to one or more embodiments, the operating method may include an operation (S920) of transmitting the homomorphically encrypted query to the server apparatus. In one example, the electronic apparatus 200 may transmit the homomorphically encrypted query to the server apparatus 100.

In one example, the electronic apparatus 200 may transmit the homomorphically encrypted query to the server apparatus 100 via the communication circuit 210. For example, the electronic apparatus 200 may transmit the homomorphically encrypted query to the encrypted RAG database of the server apparatus 100 via the network 10.

In one example, the server apparatus 100 may perform a search by performing the homomorphic operation between the homomorphically encrypted query received from the electronic apparatus 200 and the homomorphically encrypted information stored in the encrypted RAG database. For example, the server apparatus 100 may calculate a similarity value by performing the inner product or distance operation between the homomorphically encrypted query and the homomorphically encrypted embedding vector.

The server apparatus 100 performs homomorphic operations on a homomorphically encrypted query and homomorphically encrypted information in a ciphertext state without decrypting the homomorphically encrypted query and the homomorphically encrypted information, thereby preventing the content of the user input from being exposed to the server apparatus 100.

According to the above-described example, the electronic apparatus 200 homomorphically encrypts the query obtained based on the user input and transmits the homomorphically encrypted query to the server apparatus 100, thereby enabling the search of the encrypted RAG database without exposing the user's query to the server.

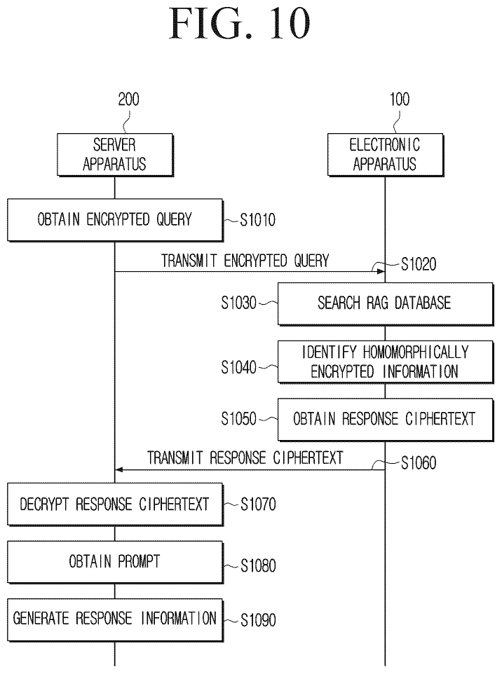

FIG. 10 is a sequence diagram for describing a system including a server device and an electronic device according to one or more embodiments of the present disclosure.

Referring to FIG. 10, the system according to one or more embodiments may include the electronic apparatus 200 and the server apparatus 100.

According to one or more embodiments, the electronic apparatus 200 may obtain the encrypted query (S1010).

According to one or more embodiments, the electronic apparatus 200 may generate a query vector based on a user input and homomorphically encrypt the generated query vector to obtain the encrypted query. For example, the electronic apparatus 200 may apply an embedding model to a user input (e.g., “Tell me my schedule for tomorrow”) to generate a query vector and homomorphically encrypt the query vector using a public key.

According to one or more embodiments, the electronic apparatus 200 may transmit the encrypted query to the server apparatus 100 (S1020).

In one example, the electronic apparatus 200 may transmit the encrypted query to the encrypted RAG database of the server apparatus 100 via the communication circuit 210.

According to one or more embodiments, the server apparatus 100 may search the RAG database (S1030).

In one example, the server apparatus 100 may perform a search by performing the homomorphic operation between the encrypted query received from the electronic apparatus 200 and the homomorphically encrypted information stored in the encrypted RAG database. For example, the server apparatus 100 may perform the inner product operation or the distance operation between the encrypted query and the homomorphically encrypted embedding vector as the homomorphic operation to calculate a similarity value.

According to one or more embodiments, the server apparatus 100 may identify the homomorphically encrypted information (S1040).

In one example, the server apparatus 100 may identify the homomorphically encrypted information similar to the encrypted query based on the similarity value calculated through the homomorphic operation. For example, the server apparatus 100 may identify the homomorphically encrypted information having the highest similarity value or a value greater than or equal to a predetermined threshold.

According to one or more embodiments, the server apparatus 100 may obtain the response ciphertext (S1050).

According to one or more embodiments, the server apparatus 100 may obtain the response ciphertext based on the identified homomorphically encrypted information. For example, the server apparatus 100 may obtain the encrypted text information associated with the identified homomorphically encrypted embedding vector as the response ciphertext.

According to one or more embodiments, the server apparatus 100 may transmit the response ciphertext to the electronic apparatus 200 (S1060).

In one example, the server apparatus 100 may transmit the response ciphertext to the electronic apparatus 200 via the communication circuit 110.

According to one or more embodiments, the electronic apparatus 200 may decrypt the response ciphertext (S1070).

In one example, the electronic apparatus 200 may decrypt the response ciphertext received from the server apparatus 100 using the secret key.

According to one or more embodiments, the electronic apparatus 200 may obtain the prompt (S1080).

In one example, the electronic apparatus 200 may obtain the prompt based on the decrypted response ciphertext. For example, the electronic apparatus 200 may obtain the decrypted text information (e.g., “Meeting with Manager A on Mar. 15, 2025”) as the prompt.

According to one or more embodiments, the electronic apparatus 200 may generate the response information (S1090).

In one example, the electronic apparatus 200 may input the prompt into the neural network model to generate the response information. For example, the electronic apparatus 200 may input a combination of prompts and user input into the small language model (SLM), the large language model (LLM), or the large multimodal model (LMM) and generate the personalized response information (e.g., “I have a meeting with Manager A scheduled for tomorrow at 2 PM”).

Meanwhile, while FIG. 10 illustrates the operation between a single electronic apparatus 200 and the server apparatus 100, the present disclosure is not limited thereto, and the plurality of electronic apparatuses 200-1 to 200-n may interact with the server apparatus 100.

In one example, the second electronic apparatus among the plurality of electronic apparatuses 200-1 to 200-n may homomorphically encrypt at least one information stored in the second electronic apparatus and transmit the homomorphically encrypted information to the server apparatus 100. The server apparatus 100 may store the homomorphically encrypted information received from the second electronic apparatus 200-2 in the encrypted RAG database. Thereafter, when the first electronic apparatus 200-1 transmits the encrypted query to the server apparatus 100, the server apparatus 100 may search the homomorphically encrypted information stored by the second electronic apparatus 200-2 and transmit the response ciphertext to the first electronic apparatus 200-1 based on the search results. In this way, the encrypted RAG database may be shared among the plurality of electronic apparatuses 200-1 to 200-n, allowing users to receive personalized AI services on any electronic apparatus, regardless of the electronic apparatus that stored the data.

Meanwhile, returning to FIG. 2, according to one or more embodiments, the processor 120 may generate the encrypted RAG database.

In one example, upon receiving the document data (e.g., PDF, text file, etc.) from the electronic apparatus 200, the processor 120 may automatically generate the encrypted embedding vector based on the document data. For example, the processor 120 may perform document processing, such as layout analysis or optical character recognition (OCR), on document data to extract text information and may apply the embedding model to the extracted text information to generate the embedding vector.

In one example, the processor 120 may homomorphically encrypt the generated embedding vector and store the homomorphically encrypted embedding vector in the encrypted RAG database. For example, the processor 120 may homomorphically encrypt the embedding vector using the public key received from the electronic apparatus 200, associate the homomorphically encrypted embedding vector with the encrypted original text information, and store the encrypted embedding vector in the encrypted RAG database.

According to one or more embodiments, the processor 120 may manage an encryption key associated with the homomorphic encryption.

In one example, the server apparatus 100 may include an encryption key management system, and the processor 120 may distribute and manage encryption keys for plurality of electronic apparatuses 200-1 to 200-n through the encryption key management system. For example, the processor 120 may perform encryption key authentication of the electronic apparatus 200 and allow access to the encrypted RAG database only to the authenticated electronic apparatus 200.

According to one or more embodiments, the processor 120 may monitor system resources.

In one example, the processor 120 may monitor resource usage (e.g., CPU usage, memory usage, GPU usage, etc.) of the homomorphic operation server and optimize the processing of the homomorphic operation based on the monitoring results. For example, the processor 120 may adjust the processing order of queries received from the plurality of electronic apparatuses 200-1 to 200-n or dynamically adjust the computational resources allocated to the homomorphic operation.

According to one or more embodiments, the processor 120 may perform a guardrail function.

In one example, the processor 120 may monitor hallucination during the generation of the response ciphertext. The hallucination may refer to a phenomenon in which the neural network model generates incorrect information that is not based on actual data. For example, the processor 120 may verify the consistency between the search results and the generated response, and when the hallucination is detected, the processor may filter the response or transmit warning information to the electronic apparatus 200.

Meanwhile, returning to FIG. 7, according to one or more embodiments, the electronic apparatus 200 may be linked to a portable key injector.

In one example, the electronic apparatus 200 may obtain an encryption key (e.g., a private key, a public key, etc.) from the portable key injector. The portable key injector may be an external apparatus for securely storing and injecting the encryption key into the electronic apparatus 200. For example, the electronic apparatus 200 may obtain an encryption key via a wired or wireless connection with a portable key injector and perform the homomorphic encryption or decryption using the obtained encryption key.

According to one or more embodiments, the electronic apparatus 200 may be integrated with an existing database system.

In one example, the processor 220 may query the database of the existing system based on the user input. For example, the processor 220 may use Text2SQL technology to convert the user's natural language input into an SQL query and use the converted SQL query to query the database of the existing system. The processor 220 may combine the query results with the search results from the encrypted RAG database to generate the response information.

According to one or more embodiments, the processor 220 may manage the user's preferences and usage history.

In one example, the processor 220 may store a history of the user's previous queries and responses in the memory 230 and generate the personalized response based on the stored history. For example, the processor 220 may store the user's preferences (e.g., response format, language settings, etc.) and adjust the output of the neural network model based on the stored preferences.

The above-described embodiments may be applied not only to a personal multi-device environment but also to a corporate or institutional environment. In one example, the server apparatus 100 may be implemented within the internal network of a corporate or institutional network and may be linked with electronic apparatuses 200-1 to 200-n used by multiple users. In this case, the encrypted RAG database may be built based on confidential corporate or institutional documents (e.g., laws, directives, internal regulations, etc.), and the server apparatus 100 may manage user-specific access rights through an encryption key management system.

In one example, the server apparatus 100 may be implemented based on micro service architecture (MSA). For example, the server apparatus 100 may implement services such as an API gateway, an interactive agent, a RAG service, authentication/authorization management, vector search, and monitoring as independent micro services. Accordingly, the server apparatus 100 may be easily linked with an existing information support system and may be independently expanded for each service.

Although various embodiments have been described above, each embodiment is not necessarily implemented individually, and may be implemented together in a single product by being combined in whole or in part with at least one other embodiment.

Various embodiments of the present disclosure may be implemented by software including instructions stored in a machine-readable storage medium (for example, a computer-readable storage medium). A machine may be a device that invokes the stored instruction from the storage medium and may be operated depending on the invoked instruction, and may include the server apparatus 100 and the electronic apparatus 200 according to the disclosed embodiments.

For example, a non-transitory readable storage medium storing software for sequentially performing various steps as illustrated in FIG. 10 may be provided.

A device equipped with such a non-transitory readable medium can perform operations such as public key generation, encryption, and decryption described in the various embodiments described above.

The term “non-transitory” in the non-transitory readable storage medium means that the storage medium is tangible without including a signal, and does not distinguish whether data are semi-permanently or temporarily stored in the storage medium.

Alternatively, a program for performing the method according to the various embodiments described above may be distributed online through an application store. In case of the online distribution, at least a portion of the computer program product may be at least temporarily stored in a storage medium such as a memory of a server of a manufacturer, a server of an application store, or a relay server or be temporarily generated.

Each of components (for example, modules or programs) according to various embodiments described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

Although the present disclosure has been described with reference to the accompanying drawings, the scope of the present disclosure is determined by the claims to be described below and should not be construed as being limited to the foregoing embodiments and/or drawings. It should be clearly understood that improvements, modifications, and alterations of the present disclosure described in claims that are obvious to those skilled in the art are also included in the scope of the rights of the present disclosure.

What is claimed is:

1. A server apparatus, comprising:
a communication circuit configured to communicate with at least one electronic apparatus;
at least one processor including a processing circuitry; and
a memory configured to store an encrypted retrieval-augmented generation (RAG) database including instructions, one or more storage media, and at least one homomorphically encrypted information,
wherein the instructions, when individually or collectively executed by the at least one processor, cause the server apparatus to search the encrypted RAG database based on a query obtained from a first electronic apparatus among the at least one electronic apparatus via the communication circuit,
obtain response ciphertext based on the homomorphically encrypted information identified through the search, and
transmit the response ciphertext to the first electronic apparatus via the communication circuit.

2. The server apparatus as claimed in claim 1, wherein the query is a homomorphically encrypted query, and
the instructions, when individually or collectively executed by the at least one processor, cause the server apparatus to perform a homomorphic operation between the homomorphically encrypted query and the at least one homomorphically encrypted information to perform the search.

3. The server apparatus as claimed in claim 1, wherein the instructions, when individually or collectively executed by the at least one processor, cause the server apparatus to store homomorphically encrypted information obtained from a second electronic apparatus among the at least one electronic apparatus in the encrypted RAG database, and
perform a search on the stored homomorphically encrypted information when the query is obtained from the first electronic apparatus.

4. The server apparatus as claimed in claim 1, wherein the encrypted RAG database is shared among the at least one electronic apparatus.

5. The server apparatus as claimed in claim 1, wherein the homomorphically encrypted information includes a homomorphically encrypted embedding vector,
the instructions, when individually or collectively executed by the at least one processor, cause the server apparatus to obtain response ciphertext corresponding to the homomorphically encrypted embedding vector identified through the search, and
the response ciphertext includes encrypted text information.

6. An electronic apparatus, comprising:
a communication circuit configured to communicate with a server apparatus including an encrypted retrieval-augmented generation (RAG) database;
at least one processor including a processing circuitry; and
a memory configured to store instructions, one or more storage media, and a neural network model,
wherein the instructions, when individually or collectively executed by the at least one processor, cause the electronic apparatus to transmit a query obtained based on user input to the encrypted RAG database of the server apparatus via the communication circuit,
decrypt response ciphertext to obtain a prompt when obtaining the response ciphertext from the server apparatus, and
input the prompt into the neural network model to generate response information.

7. The electronic apparatus as claimed in claim 6, wherein the neural network model is a small language model (SLM), a large language model (LLM), or a large multimodal model (LMM) executed within the electronic apparatus.

8. The electronic apparatus as claimed in claim 6, wherein the instructions, when individually or collectively executed by the at least one processor, cause the electronic apparatus to homomorphically encrypt at least one information stored in the electronic apparatus, and
transmit the homomorphically encrypted information to the server apparatus via the communication circuit.

9. The electronic apparatus as claimed in claim 6, wherein the instructions, when individually or collectively executed by the at least one processor, cause the electronic apparatus to homomorphically encrypt the query obtained based on user input, and
transmit the homomorphically encrypted query to the server apparatus via the communication circuit.

10. A method of operating a server apparatus, comprising:
searching an encrypted retrieval-augmented generation (RAG) database including at least one homomorphically encrypted information based on a query obtained from a first electronic apparatus among at least one electronic apparatus;
obtaining response ciphertext based on the homomorphically encrypted information identified through the search; and
transmitting the response ciphertext to the first electronic apparatus.

11. The method as claimed in claim 10, wherein the query is a homomorphically encrypted query, and
the searching includes performing a homomorphic operation between the homomorphically encrypted query and the at least one homomorphically encrypted information to perform the search.

12. The method as claimed in claim 10, further comprising:
storing homomorphically encrypted information obtained from a second electronic apparatus among the at least one electronic apparatus in the encrypted RAG database; and
performing a search on the stored homomorphically encrypted information when the query is obtained from the first electronic apparatus.

13. The method as claimed in claim 10, wherein the encrypted RAG database is shared among the at least one electronic apparatus.

14. The method as claimed in claim 10, wherein the homomorphically encrypted information includes a homomorphically encrypted embedding vector,
the obtaining of the response ciphertext includes obtaining the response ciphertext corresponding to the homomorphically encrypted embedding vector identified through the search, and
the response ciphertext includes encrypted text information.

15. The method as claimed in claim 10, wherein the response ciphertext is decrypted in the first electronic apparatus and input to a neural network model stored in the first electronic apparatus.
